(19) United States
(12) Patent Application Publication
(10) Pub. No.: US 2024/0292171 A1
(43) Pub. Date: Aug. 29, 2024

(54) SYSTEMS AND METHODS FOR EFFICIENT AND ACCURATE VIRTUAL ACCOUSTIC RENDERING

(71) Applicant: UNIVERSITY OF LOUISVILLE RESEARCH FOUNDATION, INC., Louisville, KY (US)

(72) Inventor: Matthew Neal, Louisville, KY (US)

(21) Appl. No.: 18/692,741

(22) PCT Filed: Sep. 15, 2022
(86) PCT No.: PCT/US2022/043722

§ 371 Date: Mar. 15, 2024

Related U.S. Application Data
(60) Provisional application No. 63/244,677, filed on Sep. 15, 2021.
(60) Provisional application No. 63/358,581, filed on Jul. 6, 2022.
(60) Provisional application No. 63/391,515, filed on Jul. 22, 2022.

(51) Int. Cl. H04S 5/00; H04S 3/02

(52) U.S. Cl. CPC H04S 5/005; H04S 3/02; H04S 2400/01; H04S 2420/01

(57) ABSTRACT

Systems and methods are provided for generating processing algorithms, and using such processing algorithms, to efficiently and accurately render virtual sound fields. Systems implementing such techniques can generate a virtual acoustic rendering, from an input audio signal comprising at least one sound source signal. Such systems apply PC weights to the at least one sound source signal of the input audio signal to obtain at least one weighted audio stream, wherein the PC weights were obtained from a principal components analysis of a set of head-related transfer functions (HRTFs); apply a set of PC filters to the at least one weighted audio stream to obtain filtered audio streams, wherein the PC filters were obtained from a principal components analysis of the HRTFs; sum the filtered audio streams into at least two output channels; and transmit the at least two output channels for playback by the at least two speakers, to generate a virtual acoustic rendering to a listener.

### CROSS-REFERENCE TO RELATED APPLICATION(S)

This application claims priority to U.S. Provisional Application No. 63/244,677 filed Sep. 15, 2021, U.S. Provisional Application No. 63/358,581 filed Jul. 6, 2022, and U.S. Provisional Application No. 63/391,515 filed on Jul. 22, 2022, all contents of which are hereby incorporated by reference in their entirety for all purposes.

### STATEMENT REGARDING FEDERALLY SPONSORED RESEARCH

None.

### BACKGROUND

In a variety of industries and applications, it may be desirable to virtually reproduce the auditory characteristics of a given real-world scene or location, through complex processing of the sound sources generating audio signals to be replayed to a user via various types of loudspeakers. The term “virtual acoustics” is often used to refer to this process. In some applications, virtual acoustics can involve several different steps or stages, often encompassing many processing elements. A virtual acoustic pipeline typically first involves obtaining location/scene simulations, measurements, or recordings. Then, a sound field analysis or parameterization step breaks up room information into specific pieces, whether they be individual room reflections calculated from an impulse response, diffuse/directional sound field components extracted from a spherical microphone array recording, or spherical harmonic (SH) components of a higher-order Ambisonics (HOA) signal. Finally, the sound field is rendered for a listener using either an array of loudspeakers in an acoustically dead environment or a pair of headphones. At each of these stages, the simulation, measurement, sound field analyzer, or sound field renderer can introduce errors that can potentially degrade the accuracy of a virtual acoustic algorithm. The extent to which these inaccuracies can be tolerated is context specific and depends upon the specific virtual acoustic effect that is being demonstrated. For example, to demonstrate the differences between a large, reverberant room and a smaller, more dry room, inaccuracies in timbre and localization may be tolerable. But to demonstrate the impact of introducing a single early reflection in a music performance venue, timbral or spatial inaccuracies could have a strong impact.

Although much work has occurred in the space of virtual acoustics, all current methods typically produce inaccurate results in certain contexts, especially in terms of accurate localization and perceived timbre or coloration. Although accuracy can be increased by adding more loudspeakers to an array or increasing the SH order used to represent a high-resolution head related transfer function (HRTF) set, all existing methods still show errors, even when using loudspeaker arrays with more than 1000 loudspeakers or HRTF sets with up to 35th order SH. These errors seem to be most related to the high spatial complexity of the HRTF, and this may be due to complexity at high frequencies and in the contralateral ear. Combined with the extremely high sensitivity of the human auditory system to frequency domain cues, this high spatially complexity is very difficult to accurately render with currently used rendering algorithms.

Although it makes intuitive physical sense to represent the properties of a complex sound field in a spatial domain, the human auditory system's mechanism for generating a spatial representation of a sound field is inherently indirect. Some of the cues for spatial perception result from interaural time delays (ITDs), interaural level delays (ILDs), and spectral notches in an HRTF. The auditory system uses these time-frequency cues to infer spatial locations for sound sources in a complex scene. Although some of the primary sensitivities for spatial hearing are not inherently spatial, virtual acoustic rendering algorithms are designed to operate in the spatial domain, working with loudspeakers placed in a discrete spatial location, or working with HRTFs fit to sets of spatial basis function, such as SHs.

As such, it would be desirable to have a sound field rendering algorithm with a virtual acoustic filter bank that is better matched to cues used by the human auditory system, in order to produce a more accurate representation of a sound field.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for processing audio signals to efficiently render accurate virtual acoustics.

In one implementation, a system for generating a virtual acoustic rendering is provided. The system comprises an input connection, configured to receive an input audio signal comprising at least one sound source signal; an output connection, configured to transmit modified output signals to at least two speakers; a processor; and a memory having a set of instructions stored thereon which, when executed by the processor, cause the processor to: receive the input audio signal from the input connection; apply PC weights to the at least one sound source signal of the input audio signal to obtain at least one weighted audio stream, wherein the PC weights were obtained from a principal components analysis of a set of head-related transfer functions (HRTFs); apply a set of PC filters to the at least one weighted audio stream to obtain filtered audio streams, wherein the PC filters were obtained from a principal components analysis of the HRTFs; sum the filtered audio streams into at least two output channels; and transmit the at least two output channels for playback by the at least two speakers, to generate a virtual acoustic rendering to a listener.

In another implementation a method is provided for generating a virtual acoustic rendering corresponding to the steps of the software instructions of the foregoing implementation.

In another implementation, a method is provided for allowing a listener to hear the effect of hearing aids in a simulated environment, the method comprising: receiving an audio signal comprising a multiple sound source signals in an audio environment; applying PC weights and PC filters to each of the sound source signals to result in a set of weighted, filtered channels, wherein some of the PC weights and PC filters are based upon a set of HRTFs and some of the PC weights and PC filters are based upon a set of HARTFs; summing the weighted, filtered channels into at least one unaided output and at least one aided output; and rendering a simulated audio environment to the listener, wherein the simulated sound environment can selectively be based upon the unaided output or a combination of the unaided output and the aided output to thereby allow the listener to hear the effect of using a hearing aid or not in the simulated environment.

In another implementation, a system is provided having an input connection, an output connection, a processor, and a memory, the memory having thereon a set of software instructions which, when executed by the processor, cause the processor to perform actions corresponding to the steps of the method of the foregoing implementation.

In another aspect of the disclosure, a method is provided for simulating an acoustic environment of a virtual reality setting, the method comprising: receiving an audio signal comprising multiple sound source signals in an audio environment, the audio environment corresponding to a visual environment to be displayed to a user via virtual reality; applying PC weights and PC filters to each of the multiple sound source signals, to result in a set of weighted, filtered channels, the PC weights and PC filters having been derived from a set of device-related transfer functions (DRTFs); summing the weighted, filtered channels into at least two outputs; and rendering a simulated audio environment to a listener via at least two speakers.

In another aspect of the disclosure, a system is provided having an input connection, an output connection, a processor, and a memory, the memory having thereon a set of software instructions which, when executed by the processor, cause the processor to perform actions corresponding to the steps of the method of the foregoing implementation.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flowchart illustrative a method for generating a PCBAP-based audio algorithm in accordance with the present disclosure.

FIG. 2 is a flowchart illustrating a method for applying a PCBAP-based audio algorithm to simulate an audio environment in accordance with the present disclosure.

FIG. 3a is a diagram visually representing data flow in a typical HRTF-based method for attempting to generate a simulation of an audio environment.

FIG. 3b is a diagram visually representing data flow in embodiments of the present disclosure implementing a form of PCBAP-based simulation of audio environments.

FIG. 4 is a diagram visually representing data flow in embodiments of the present disclosure implementing a form of PCBAP-based simulation of audio environments.

FIG. 5 is a diagram visually representing data flow in embodiments of the present disclosure implementing a form of PCBAP-based simulation of audio environments.

FIG. 6 is a graph showing the average number of PC filters used to render either collocated or matched audio source recognition, based on a study of listeners.

### DETAILED DESCRIPTION

### Introduction

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

The inventors have determined that an effective way to overcome the limitations of the prior art and provide for improved rendering of sound fields is to utilize the techniques and algorithms described herein pertaining to a reduced set of filters that leverage redundancy in HRTFs to exploit the large amount of shared variance in an HRTF set without enforcing a specific spatial representation upon the shared variance. Importantly, the way in which the reduced set of filters is acquired not only provides reduced computational complexity, but actually improves sound rendering and reduces errors in sound environment recreation when compared to prior methods. The new techniques and algorithms disclosed herein may be implemented in a variety of hardware embodiments, to provide improved sound field rendering in many different applications.

As described below, in some embodiments a set of perceptually focused filters can be developed using time-domain principal component analysis (PCA). The resulting principal components (PCs) generate a set of finite impulse response (FIR) filters that can be implemented as a sound field rendering engine, and the PC weights can be used as panning functions/gains to place an arbitrary source in space. As such, a category of techniques described herein can be referred to as principal component-based amplitude panning (PCBAP). A PCBAP filter set is much better suited for perceptually accurate sound field rendering than loudspeaker array HRTFs or HRTFs fit to SH functions.

In other embodiments, a PCA is used on the combined real and imaginary components of the HRTF, to generate the PCBAP filter set in the frequency domain. Time-domain FIR filters can then be created using an inverse Fourier transform on the frequency domain PCBAP filters resulting from the PCA. In such embodiments, the real and imaginary components are combined and input to the principal components analysis operation as separate real-valued numbers, to ensure that the PC weights are also real-valued, and can be efficiently applied in the rendering algorithm, without requiring a frequency-domain transformation. Other embodiments may also run a frequency domain principal components analysis on magnitude and phase data of an HRTF, rather than real and imaginary components of the HRTF.

For both time-domain and frequency-domain PCBAP filter generation, the principal components analysis results in sets of finite impulse response (FIR) filters. Some embodiments may increase the efficiency of the PCBAP rendering algorithm by truncating or reducing the number of points in each PCBAP filter, or by fitting infinite impulse response (IIR) filters to the PCBAP filters, as IIR filters are known to be more efficient than FIR filters, generally. These IIR filters may be designed by fitting based upon the magnitude of the FIR filters in the frequency domain or based upon the real and imaginary components of the HRTF (otherwise known as magnitude and phase, or complex-valued HRTF). Additional known techniques for designing more efficient IIR filters based upon FIR filter targets can also be used to further optimize the PCBAP algorithm.

The present disclosure presents novel PCBAP algorithms, as well as data comparing various algorithms of the present disclosure to existing loudspeaker array and headphone-based rendering techniques.

Principal component analysis (PCA) is a technique which simplifies a dense multivariate dataset into a compact set of underlying functions that are mapped to original samples from the dense dataset. This compact representation can be mathematically performed using eigendecomposition of the dense dataset. The resulting basis function from the PCA, often called the principal components (PCs), can then be linearly combined to approximate the original observations in the dense dataset using principal component weights (PCWs). This linear summation has an analogy to Fourier analysis, where signals can be reconstructed through weighted sums of sine and cosine basis functions using a time-domain Fourier transform, or weighted sums of spherical harmonic (SH) functions using the spherical Fourier transform. One difference between PCA and Fourier analysis is in how basis functions are determined. While Fourier analysis uses a prescribed set of basis functions from the solution of the wave equation, PCA defines a set of basis functions based upon the underlying variance in a dense dataset. One advantage of PCA is data reduction. Assuming a high degree of similarity exists within a dataset, it is likely that the overall complexity of that dataset can be represented with a sparse set of PCs. Another benefit of the resulting PCs is that they are independent (orthogonal) and have no shared variance with one another. In other words, the PCs are uncorrelated, each representing a unique component of the original data set's variance. Such a representation can also help to better understand and interpret large datasets.

In the context of an HRTF, each frequency bin of the HRTF is considered a unique variable, and each unique HRTF for a given ear and direction represents a new observation or sample in the dataset. When a PCA is performed on a set of HRTF magnitude spectra, this analysis would result in a set of magnitude spectra PCs functions, the same dimension as the original data. The PCA also results in linear PCW, sometimes called PC scores, used to approximate the original HRTF magnitude spectra observations. Since the magnitude spectra of the HRTF contains real-valued components only, the resulting PCW will also be real numbers.

It bears noting that analyzing the acoustics of the human head using PCA can focus on the frequency domain, but it is also possible to perform PCA on time-domain head-related impulse response (HRIR) sets. This latter technique would result in PCs that resemble time-domain HRIRs, and real-valued PC scores. Since the auditory system is known to primarily operate as a frequency-domain analyzer with high sensitivity, much of the original HRTF work focused on analysis in the frequency domain. It is also mathematically valid to conduct PCA on time-domain HRIRs, however. Although time-domain representation of the data is seemingly less directly focused on frequency-related spatial hearing cues, the time domain HRIR still contains the same magnitude and phase information, just in a different representation. A benefit of time-domain analysis is that the data are entirely real data, and the resulting weighting functions will be composed of real-valued weights, rather than the complex weights which result from a complex-valued frequency-domain analysis. A real-valued weight can be applied purely in the time domain, and therefore has the advantage of decreasing computing requirements for real-time processing. And, as noted above, the present disclosure also contemplates deriving PC weights/filters via the frequency domain, while still ensuring the PC weights are real-valued.

In the following description, various examples will be described to show how PCA techniques can be used to define a perceptually and physically accurate binaural rendering algorithm.

### Principal Components Analysis

Past virtual acoustic techniques tended to be spatially-focused, designing loudspeaker arrays with physical locations in 3D space, and mapping this representation to the physical location of virtual sources. This design fundamentality assumed that the acoustic cues the auditory system uses to locate a sound source and judge the timbre or ‘color’ of a sound source is best sampled in the spatial domain. Although spatial accuracy in the positioning of the virtual sound source is an important goal, spatial hearing in the human auditory system is known to be an indirect mechanism. The auditory system uses a combination of monaural and binaural cues that are a function of both time and frequency, and from these cues, infers a spatial location of a sound source. Although errors in perceived direction are of interest, these errors likely result from artifacts in the time-frequency domain cues, rather than the spatial domain. Rather than focus on sound field and spatial simulation, improved accuracy may be found if sound field rendering algorithms are instead developed with a focus on human perception. As explained below, this focus provides algorithms that are more efficient, since they would be better suited to known cues relevant for accurate perception of timbre and directional localization.

Since loudspeaker array techniques can be closely related to concepts of HRIR/HRTF interpolation, a filter bank of HRIRs/HRTFs focused on the time-frequency domain representation of auditory cues, rather than a spatial domain representation of loudspeaker positions, is better suited for virtual acoustic rendering. In other words, a cursory review of time-frequency domain PCA of HRTFs and HRIRs might initially suggest most variance can be explained with 10-30 PCs, while binaural loudspeaker array-based techniques still struggle to represent HRTFs accurately with hundreds, if not thousands of loudspeaker array HRIR/HRTF filters.

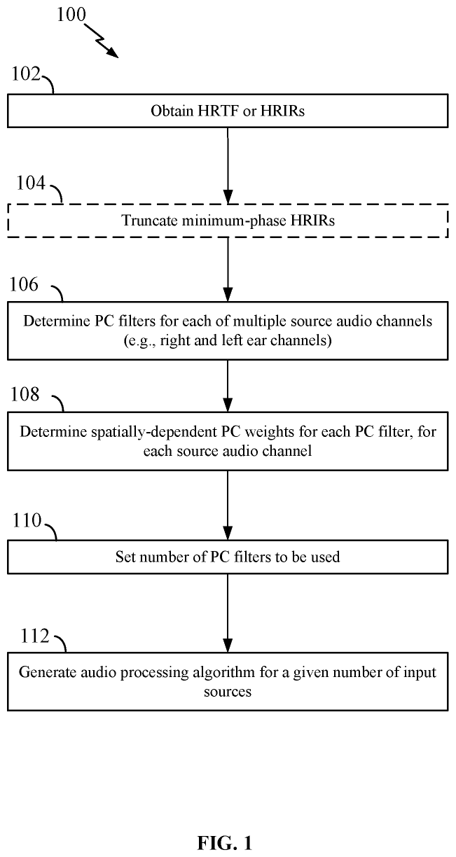

Referring now to FIG. 1, a flowchart 100 is shown, depicting a generalized procedure for developing a principal components-based method for designing a PCBAP filter set for efficient and accurate sound field rendering, including panning of audio sources to provide a realistic listening experience to a user.

At block 102, the method involves obtaining an HRTF or HRIR set reflective of how sound propagates around a specific human head. In some embodiments, it may be beneficial to begin with HRTF data, whereas in other embodiments it may be beneficial to begin with HRIR data. The HRTF and HRIR data may also be created from one another through time/frequency domain transformation operations.

Optionally at block 104, the HRIRs (or HRTFs) may be time-aligned through either applying time shifts in the time domain or through designing minimum phase HRIR/HRTF filters. For example, in one embodiment, HRIRs or HRTFs were represented as minimum-phase filters, and the HRIR delays were calculated in each direction using the threshold technique with a −12 dB onset criterion. The minimum-phase HRIRs can be truncated to, for example, 128-point filters prior to conducting the PCA. In other embodiments, time alignment can be performed by circularly-shifting the HRIR filters based upon the −12 dB onset criterion. In effect, this process can be an alternative to other time alignment procedures, which will be described with respect to subsequent Figures.

At block 106, a set of PC filters are determined for each channel of multiple audio input channels. In one embodiment, the number of channels may be two (for playback via, e.g., headphones with audio inputs corresponding to right ear channel and left ear channel). In other embodiments, the number of channels may be four, six, or other numbers to reflect, for example, audio input channels corresponding to microphones of a hearing aid plus ambient sound passed to the ear. In some embodiments, the microphones are for a headphone, hearable technology, or any augmented reality audio device that captures sound with microphones, processes the sound, and reproduces sound for a listener. In some embodiments, PC filters may be obtained by performing a principal components analysis function on HRIRs or HRTFs, and in further embodiments PC filters may be obtained by performing principal components analysis of a hearing aid-related transfer function (HARTF), (which defines the relationship and directional paths between a sound source and the hearing-aid microphone—which may be behind, over, or adjacent to an ear, as distinct from an HRTF which corresponds to the ear itself) or a device-related transfer function (DRTF) (which can be thought of as describing the relationship and directional paths between source sounds and microphones which are positioned on an augmented reality audio device or headphone). For example, when PCA is performed on minimum-phase HRIRs truncated to 128-point filters, the result will be a maximum of 128 PC filters.

A PCA is an operation that reduces a large dataset into a compact representation through calculating the eigenvectors, or principal components (PCs), of the dataset's covariance matrix. Effectively, instead of each HRTF or HRIR filter being discretely mapped to a particular direction in space, each HRTF or HRIR filter can be thought of as a linear combination of a set of basis functions, or PCs. If an HRTF or HRIR filter has common or shared variance, the PCs will be defined to represent that common or shared variance.

For any binaural source panning algorithm, a set of basis functions form a binaural rendering filter bank, and a set of gains are calculated to ‘pan’ a sound source, placing it in a given direction. For a time-domain PCA of HRIRs, the resulting PCs are reminiscent of a binaural rendering filter bank, and the PC weights are similar in nature to panning gains.

Accordingly at step 108, a set of spatially-dependent PC weights are determined as a result of the PCA of the HRTF or HRIR set. In one example, a PCA was implemented directly on a set of HRIRs for a two-channel (left and right) signal, so the resulting PC filters resembled time-domain finite impulse response (FIR) filters, and the resulting PC weights were a set of 11,950 real-valued coefficients for each ear and PC filter, one for each direction of the original HRTF. A PC-truncated HRTF was reconstructed by taking the PC filters up to a given cutoff threshold and weighting them with their corresponding PC weights for a given direction. This operation is directly analogous to a source ‘panning’ operation. PC truncations were set to values of (N+1)\hat{ }2, the number of filters used for a given spherical harmonic (SH) order, N, for comparable methods. This corresponded to PC cutoffs of N_PCs=4, 9, 16, 25, 36, 64, 100.

At block 110, the number of PC filters to be used is determined. As described herein, because of the amount of shared variance in HRIRs and HRTFs, it may be possible to achieve accurate sound field reproduction and panning without utilizing nearly as many filters as compared to using a set of HRIRs or HRTFs. Another factor that can reduce the number of filters required is whether or not the HRTFs/HRIRs are time-aligned. If time alignment is applied, then fewer PC filters can be used. Examples of embodiments using and not using the time-alignment procedure (which do not need separate delay application) are shown below. As described below, as few as around 9-10 PC filters offer sufficient rendering of sound sources, and 25-30 PC filters render a sound sources that are effectively identical to a reference sound.

At block 112, an audio processing algorithm is then generated for each of a given number of output channels. For example, in some embodiments, a left and right input channel from source audio would result in both a left and right output of the audio processing algorithm. An audio source signal having more than 2 channels (e.g., for simulating a hearing aid, or multi-channel audio device) will involve one output per hearing aid microphone or augmented reality audio device microphone. In some embodiments, both a hearing aid and the standard left and right ear output are used simultaneously. Depending upon the hardware that will be processing the audio algorithm (including processing power and memory availability, as well as any additional downstream processing that might occur via native algorithms of a hardware), the audio processing algorithm may include a separate ITD delay injection, or simply account for interaural time difference delays via the use of more PC filters. As shown in subsequent figures, the signal processing path for an audio processing algorithm will account for use of time delays, PC weights (for panning), and PC filters, as well as summing some or all channels for output via the available speakers to be used.

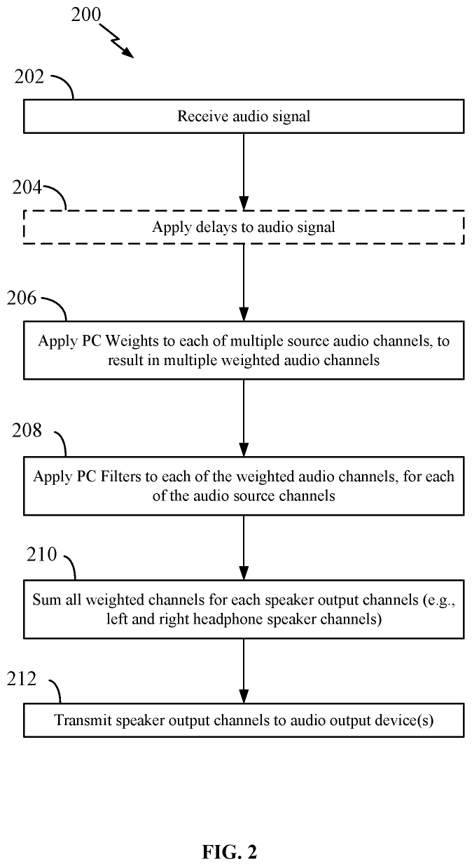

Referring now to FIG. 2, a flowchart is shown, depicting a generalized procedure 200 for applying a PCBAP method to processing of an audio signal, in order to efficiently and accurately modify the audio signal to present it to a user so as to simulate the audio environment of a given scene. At block 202, an input audio signal is received. In some embodiments, the input audio signal may comprise two channels, for the purpose of rendering multiple sound sources over a set of headphones or VR equipment. In other embodiments, the number of channels may be 2, 3, 4, or more. In some embodiments, multiple channels will correspond to the output for multiple speakers to represent a loudspeaker array. The audio signal for each input channel is copied into one or more channels before the time delays may be applied. In one embodiment, inputs are each copied into 6 channels, in order to simulate aided and unaided hearing aid performance (a natural, ambient audio source/channel, as well as modified audio channels from the multiple microphones per hearing aid). In some embodiments, audio is copied into two channels, for the purpose of rendering left and right ear signals for headphone playback of the audio algorithm output.

At block 204, a time delay may optionally be applied to each of the audio source channels of the input audio signal. As described above, interaural time delay (which humans use as a cue to interpret panning or horizontal plane origination direction) can be injected into a signal either by applying a time delay before use of PC filters and PC weights, or the PC filters themselves can apply the time delay. The time delays may also correspond to pure delays in the HRIRs. The delays can also correspond to delays in a hearing aid transfer function (HARTF) or the delay to a single reference microphone on the hearing aid. The time delay will depend upon information regarding direction of arrival of each audio source within the input audio signal.

At block 206, a set of PC weights is then applied to the multiple source audio channels, to result in multiple weighted audio channels. The specific PC weights, to be selected from a set of possible PC weights, to applied to specific audio sources will depend upon information (provided from the audio input signal itself or from additional data relating to the signal) giving the directional origin of the sound source. In some embodiments, the directional information may be given in spherical coordinates, e.g., azimuth and elevation angles. For example, within a right ear audio source channel, the input signal may include information reflecting various real-world sources of audio which, during the course of playback of the signal, are meant to “pan” across the listener's field of hearing. The PC weights apply a gain to these signals in order to simulate the panning. In other words, the PC weights can be used as panning functions/gains to place an arbitrary source in space.

At block 208, the set of PC filters are then applied to each of the weighted channels, for purposes of sound field rendering. In much the way that a complete set of HRIRs or HRTFs are used to simulate how a virtual audio source would sound when coming from a specific direction, the PC filters apply a similar modification to the weighted channels to virtually place the sources in space. However, as discussed herein, a substantially lesser number of PC filters can be used to provide an even more accurate sound rendering than the use of HRIRs or HRTFs directly.

At block 210, the weighted and filtered channels for each ear (or each loudspeaker of an array) are summed and prepared for playback via the speakers. Then at block 212, the summed output channels are transmitted to audio output devices. In some embodiments, the summed output channels are transmitted directly to amplifiers to drive speakers. In other embodiments, the summed output channels are transmitted to an audio device (such as a pair of headphones, hearing aids, stereo) which may contain its own downstream processing or compensation algorithms before playback to a user. In some embodiments, one ore more hearing aid processors will be simulated in computer software. In other embodiments, the processor will transmit output audio signals to one or more hearing aids using wireless streaming techniques. Finally, in other embodiments, the program will output signals to one or more custom hearing aids which receive audio from a wired connection, rather than microphones in the device.

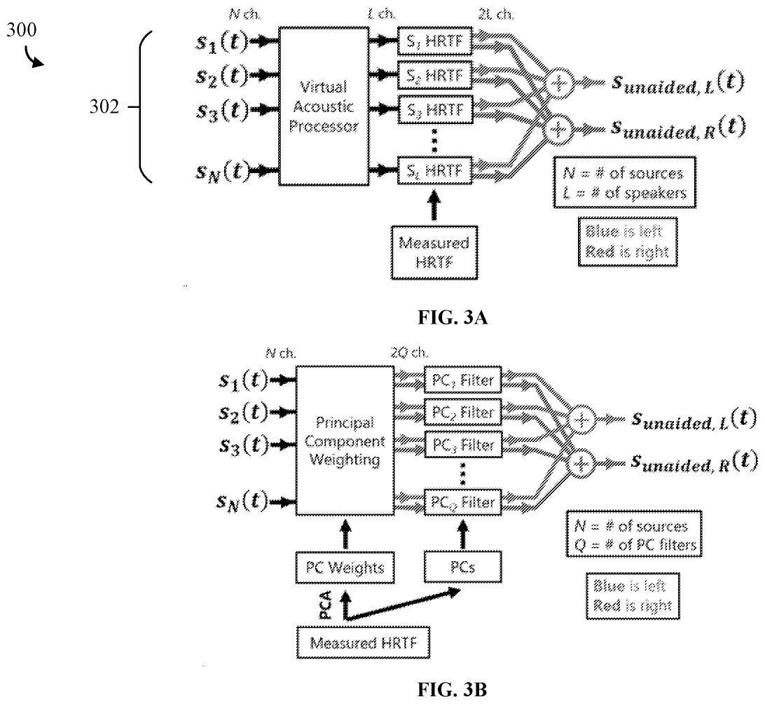

Referring now to FIG. 3, a comparison is shown of two block diagrams. FIG. 3a conceptually illustrates the signal processing path within a system that utilizes a set of HRTF filters to virtually simulate an audio scene. FIG. 3b conceptually illustrates the signal processing path within a system that utilizes a PCBAP technique to simulate a scene.

In FIG. 3a, a set of N source channels represents an incoming audio signal to be processed. To construct a virtual audio scene, multiple sources can be combined with HRTF filters from different directions and superimposed so that multiple sources can be played back simultaneously and located in different directions. One common method to perform virtual acoustics over a set of headphones or a set of loudspeakers, is to generate what is essentially a virtual loudspeaker array using HRTF filters from each loudspeaker location.

In FIG. 3a, the source audio channels are represented as a collection of source signals, labeled s₁(t) through s_{N}(t). These source signals of the input audio signal are then processed by a virtual acoustic processor. The virtual acoustic algorithm may be the same processing of source signals as done using known methods when using an array of loudspeakers (rather than simulating source sound directionality via a virtual sound field). Then, the loudspeaker signals are processed with HRTF filters corresponding to the location of each “loudspeaker”, simulating the array virtually. Alternatively, these filters can correspond to a SH representation of the HRTF as well. After summation, separately for the left and right ears, headphone playback will recreate the same sound field that would be heard if the listener were seated in the center of the loudspeaker array. If head rotation is tracked, the HRTF filters can be dynamically updated to render a sound field for a given head orientation within the array.

This approach, however, suffers from several disadvantages that are remedied via the configuration of FIG. 3b representing an embodiment of a PCBAP algorithm. For example, the approach in FIG. 3a requires substantial complexity in order to achieve higher accuracy. More specifically, in order to achieve higher accuracy in sound reproduction, the loudspeaker array size can be increased (whether using actual loudspeakers or approximating more virtual loudspeakers). Although large arrays become practically infeasible in traditional physical loudspeaker arrays, headphone-based virtual arrays can produce larger sized arrays using a still-practical hardware setup (e.g., via headphones or a VR audio setup). Still, with each virtual loudspeaker added, two new HRTF filters are required, as shown in FIG. 3a. As such, sound field rendering will directly scale in complexity with array size and/or the total number of sound sources within a particular scene. Moreover, panning a sound source across multiple virtual loudspeakers will also become exceedingly complex. When using traditional loudspeaker array techniques, sources that should directionally appear in-between the locations of array loudspeakers are estimated by driving the closest loudspeakers in the array with more energy based upon array geometry and desired source direction. This is referred to as ‘panning’ a virtual source. As such, directions in between array loudspeakers are approximated by their geometric closeness. If changes occur in the HRTF over very small changes in direction, a very dense array with many virtual loudspeakers (>100 or more) would be needed for high fidelity.

In contrast, the configuration shown in FIG. 3b provides multiple advantages. For example, this configuration allows for the use of fewer filters, greater adaptability to incorporate changes in direction, and increased accuracy without corresponding increases in complexity and number of audio rendering filters required. The signal chain for this embodiment of a PCBAP-enabled system is conceptually illustrated. As shown, this embodiment reconstructs N virtual sound sources using Q total PC filters, for playback via a two-loudspeaker physical implementation (e.g., a set of headphones, a set of hearing aids, a pair of speakers positioned to the left and right of a listener, etc.). Each source of the input audio signal (i.e., s₁(t) through s_{N}(t)) is separately weighted based upon its direction of arrival, using a set of PC weights which were derived from a set of HRTFs per the principles described above, to be applied in the time domain. In other embodiments, the PC weights could be derived from HRIRs and thus applied directly to the signals in the time domain as a set of gains. Once the PC weights have been applied, weighted copies of each source signal for the left and right playback channels are then sent to the appropriate PC filters in a PC filter bank. The PC weights are matched to specific PC filters, and these pairings directly result from the principal components analysis of the HRTFs, HRIRs, HARTFs or HARIRs. The number of filters Q will be less than the number of HRTF filters which would otherwise be required for accurate rendering under the method of FIG. 3a. However, because no ITD delay is applied to the source signals prior to PC weighting and PC filtering, the PC filters will be increase in number and/or complexity. And, while FIG. 3b appears to show that the number of PC filters equals the number of sources, that may not be the case in practice. For example, the number of PC filters available to the system may exceed the number of sources, but the directionality of a source may dictate which of the PC filters should be applied.

After summing all signals from each of the PCs (separately for the left and right ears in this example), a source will be panned to the desired location, just as it would be in a virtual loudspeaker array setup. In other embodiments, the number of sources may vary, and the number of output signals for playback may vary (e.g., according to the number of actual speakers being used), but the concepts of FIG. 3b would correspondingly apply. In some embodiments the N sources correspond to a virtual array of N loudspeakers, generating signals for a realistic sound field, possibly including reflections, reverberation, and background sounds in a complex scene.

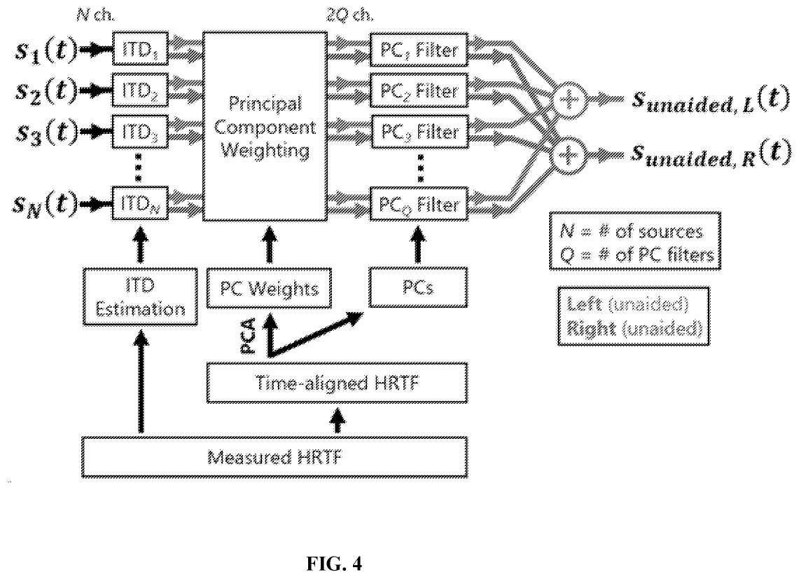

Referring now to FIG. 4, an alternative embodiment to that of FIG. 3b is shown. In this configuration, a time alignment procedure is performed first, prior to PC weighting. As shown, an ITD delay (i.e., an HRIR delay) is applied directly to the various sources s₁(t) through s_{N}(t) prior to PC weighting.

For an embodiment in which a time alignment/delay is to be applied separately from the PC filters, a slightly different procedure is used to generate the PC filters and weights from an HRTF/HRIR. In this embodiment, the PC filters are calculated after time alignment of the HRTF. This procedure reduces the complexity in the HRTF measurement set and can employ fewer PC filters to achieve the same accuracy as the embodiment of FIG. 3b. In other words, the PCA operation is performed on an HRTF set that has already been time aligned, removing time delay. In order to add back in the time delay, an ITD cue or the pure delays from the original HRIRs are applied to the left and right ear signals before the PC weights are applied. This ITD application is done separately for each sound source in the sound field, represented as N different sound sources in FIG. 4. Initial testing with human subjects show that using configurations with separate application of the time delay cues, as shown in FIG. 4, audio is perceived as coming from the correct location with as few as Q=15 filters in the PC filter bank, or with as few as Q=25 filters for producing a signal with little to no perceived differences from the high resolution HRTF measurement set.

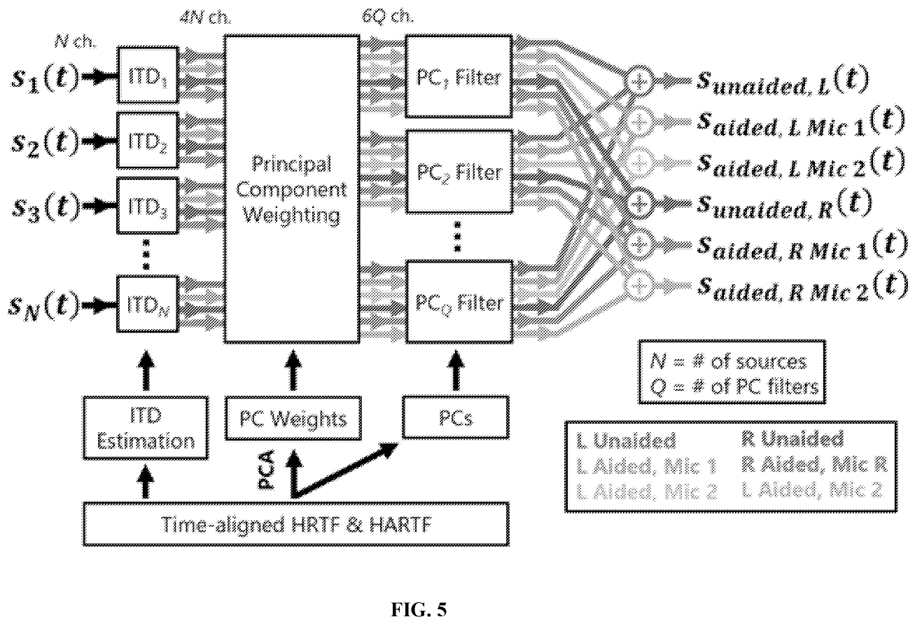

Along with virtually recreating the signals at the left and right ears for unaided virtual acoustics, PCBAP can be extended to recreating sound fields for listeners who are also wearing a hearing assistive device. Referring now to FIG. 5, a signal path representation is shown, in which an audio signal, comprising multiple sound sources, is processed by a PCBAP algorithm to result in six output channels representing the simulated aided and unaided audio for each ear of a listener wearing hearing aids (assumed to have two microphones per ear). However, it should be recognized that the signal path and algorithms reflected in FIG. 5 may also apply to acoustic rendering other than involving a hearing aid, such as instances of a personal sound amplification product, or headphones that are designed to add virtual reality (VR) or augmented reality (AR) audio capabilities.

As shown, an audio signal may comprise N channels corresponding to sound sources of an audio scene. Each audio source is copied into 4 channels as part of a time delay step to add an interaural time difference—the time delays may be thought of as HRIR delays. For each sound source, the 4 channels will correspond to left and right unaided audio, and left and right aided audio. The time delay is determined based upon a number of factors, including information regarding the directional origin of the sound source as well as corresponding time-aligned HRTFs and HARTFs.

Next, each of the four channels for each audio source undergo PC weighting. In embodiments relating to FIG. 5, HRTFs (which are, in one sense, measurements of sound to the ears—an unaided pathway) and HARTFs (which are, in a sense, measurements of sound to the hearing aid microphones—an aided pathway) are combined, such that a PCA is performed on the entire set of measurements. The resulting PC weights map each source direction to the left and right ears in the unaided pathway and to both microphones on each left and right hearing aid in the aided pathway. Where, as in FIG. 5, a time delay is applied as a separate step, the PCA is performed on time-aligned HRTFs and HARTFs. The result of application of the PC weights is sets of six weighted channels, the six members of each set representing left and right unaided audio, left and right aided audio from a first microphone of a hearing aid, and left and right aided audio from a second microphone of a hearing aid. In some embodiments, the PCA is performed separately on the HRTF and HARTF. In other embodiments, the PCA is performed on a combined set of HRTF and HARTFs.

The weighted audio channels are then processed by PC filters. As shown the number of PC filters is Q which may be a different number than N, the number of source sources. As with the PC weights, the PC filters are determined from HRTFs and HARTFs. The output of the PC filters comprises sets of six filtered audio channels, which are then summed into six output channels: left and right unaided output channels, left and right channels corresponding to a first microphone of a hearing aid, and left and right channels corresponding to a second microphone of a hearing aid. These output signals can then be utilized in a number of ways. For example, the aided output signals can be provided via connection to a set of hearing aids in lieu of their actual microphone outputs. The aided output signals would then be processed by the normal hearing aid processing, and played back to the listener. In other embodiments, the aided output signals could undergo processing by a virtual hearing aid algorithm, to simulate what a hearing aid would do to its native microphone signals, then summed back with the unaided output signal and played to a listener via a set of headphones.

In other embodiments, for example embodiments in which the PCBAP technique would be utilized for augmented or virtual reality acoustic rendering, rather than the multiple output channels corresponding to aided vs unaided hearing, the output channels could correspond to the summation of a number of virtual sources to be placed into space. For example, in an AR setting, a virtual sound could be processed by such a PCBAP method, and then summed with raw ambient audio (either electronically or simply by the human ear) to augment natural hearing. In a VR setting, maximum audio fidelity and experience could be achieved using the PCBAP technique described above.

### Experiments and Performance

In the inventors' experiments, the inventors have found that a surprisingly low number of PC filters can be utilized while still achieving high accuracy and sound rendering. For example in one experiment, an embodiment according to the techniques of FIG. 5 in which nine PC filters were used achieved a similar error to that of an array of 121 loudspeakers implementing an ITD-optimized headphone-based virtual acoustic technique.

In another experiment, performance comparisons between systems utilizing PCBAP versus traditional loudspeaker array methods were incomparable without using arrays with over 5000 loudspeakers. For array sizes which met a minimum 95% cue error threshold of 3 dB for TL and ILD, the PCBAP system required 89.9-99.5% less filters than systems utilizing prior methods like prior delays HOA and prior delays VBAP.

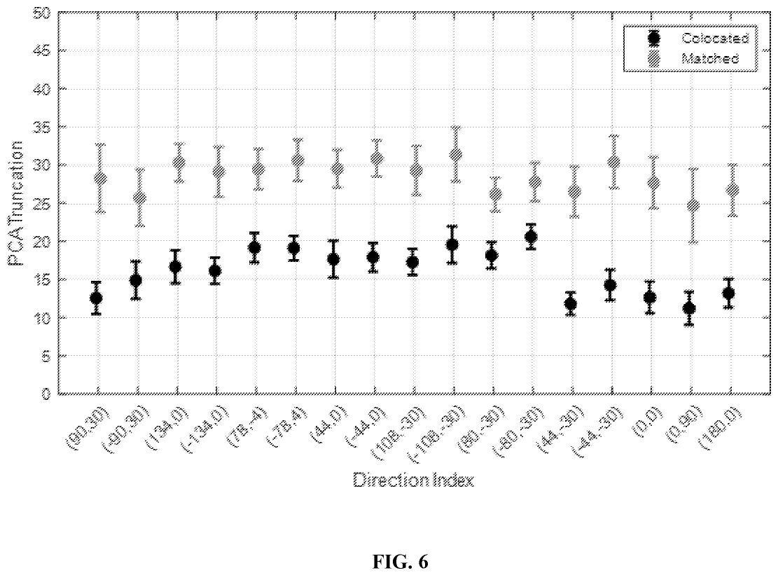

Referring to FIG. 6, a graph is shown plotting the mean number of PC filters that were used in order for listeners to a given audio source to perceive the audio source as either collocated with a reference source or matched to the reference source. To quantify how many PC filters should be used for accurate reproduction of a sound field, an initial listening test was conducted by the inventor in which subjects identified at what point (through varying amounts of PC filters) a virtual sound source was either indistinguishable from a reference, ground truth HRTF (matched) or located in the same point in space as the ground truth HRTF (collocated). Subjects were given a slider that controlled how many PC filters were being used by the PCBAP algorithm, and subjects moved the slider until the PCBAP virtual sound source sounded collocated with the ground truth reference, or until the virtual PCBAP source was perfectly matched to the reference condition. The task was repeated for 17 different source directions around a listener's head, and means and standard errors are presented for the task in FIG. 6. The data contains results using 10 subjects, all who were screened for normal hearing, and each subject ran the task twice.

FIG. 6 plots the averages over a number of different source directions (specified by azimuth and elevation angles). For all directions, the average subject required 25-32 PC filters to produce a source identical to the reference, and only 10-21 PC filters to produce a source that was collocated with the reference. From discussions with the subjects and informal listening by the authors, the higher filter cutoffs for the matched conditions appear to be due to very small spectral/timbral shifts that are very small differences, but due to the fine frequency sensitivity of the auditory system, these errors are still easily detected by subjects. The collocated condition was a less strict criterion for similarity, only requiring identical source location and allowing for differences in pitch/frequency/timbre. This criterion is suggested as a better criterion for assessing the quality of a virtual acoustic algorithm, whose primary goal is to produce a plausible sound source from the proper direction, with little negative impact from small timbral artifacts.

### Other Example Implementations

In one additional implementation, the PCBAP techniques described above could be utilized to provide a system to simulate aided listening in complex environments with different hearing aid designs, brands, and hearing aid algorithms. This would allow hard of hearing individuals to realistically simulate wearing a given type of hearing aid, or having a given type of hearing assistance, in a variety of audio scenes—without having to leave the listener's home, an audiologist's office, or other location. For example, a system could be implemented in an audiological clinic to assist in the fitting of hearing aids in settings similar to normal use conditions. A set of HARTFs corresponding to various designs and brands of hearing aids could be used to generate banks of HRIR delays, PC weights, and PC filters for simulating what a user would experience wearing those designs/brands. (For example, different hearing aid designs may have more or fewer microphones per ear, or have the microphones located in spatially-different locations relative to the ear canal, which can be captured via HARTFs). Then, audio signals comprising audio sources simulating scenes like a noisy restaurant, sporting event, busy rush hour traffic, etc. can be processed via PCBAP and played back to the listener to let the listener virtually “test” different hearing aids or hearing aid algorithms.

In another additional implementation, PCBAP techniques can be used as an algorithm directly deployed on any VR or AR audio device. This device could be a VR/AR headset, or it could be a pair of hearing aids, headphones, or hearable audio technology. The techniques described herein could precisely place sound objects in space for virtual audio processing, in a way that does not demand particularly heavy computational resources. Also, if the device had sensors to provide head rotation and positional tracking and updating (e.g., the device incorporates an accelerometer, such as in AR devices that incorporate mobile phones, or have native accelerometers), head rotation could be efficiently implemented with the PCBAP algorithms. In other words, as a head rotates, tilts, or turns, the relative direction of a given audio source changes with respect to the listener's ear, which makes use of different filters and weights desirable. With PCBAP filters and weights, greater flexibility can be achieved given that fewer filters/weights are needed as compared to traditional use of HRTFs.

In another implementation, the techniques and embodiments described herein could be deployed in gaming systems and similar environments utilizing audio. The scalability and smaller number of filters involved in PCBAP techniques makes these techniques well suited to such applications.

In other implementations, a simulated training or demonstration where audio fidelity is important would benefit from use of PCBAP techniques. For example, systems that implement training in complex or harsh environments, where a sense of hearing and source identification is important and relevant to training, could leverage PCBAP techniques to rapidly adapt to user and source movement. Similarly telepresence systems could utilize PCBAP to increase realism and accuracy of spatial audio implementation.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A system for generating a virtual acoustic rendering, comprising:
an input connection, configured to receive an input audio signal comprising at least one sound source signal;
an output connection, configured to transmit modified output signals to at least two speakers;
a processor; and
a memory having a set of instructions stored thereon which, when executed by the processor, cause the processor to:
receive the input audio signal from the input connection;
apply PC weights to the at least one sound source signal of the input audio signal to obtain at least one weighted audio stream, wherein the PC weights were obtained from a principal components analysis of a set of head-related transfer functions (HRTFs);
apply a set of PC filters to the at least one weighted audio stream to obtain filtered audio streams, wherein the PC filters were obtained from a principal components analysis of the HRTFs;
sum the filtered audio streams into at least two output channels; and
transmit the at least two output channels for playback by the at least two speakers, to generate a virtual acoustic rendering to a listener.

2. The system of claim 1, wherein the instructions further cause the processor to apply a time delay to the at least one sound source signal, prior to applying the PC weights.

3. The system of claim 2 wherein each time delay is selected from a set of ITD delays according to directional information of a source signal, the ITD delays having been obtained from a principal components analysis of the HRTFs, for each direction in which an HRTF was measured.

4. The system of claim 1 wherein the set of PC filters comprises a quantity of filters that is less than the HRTFs of the set of HRTFs.

5. The system of any of claims 1-4 wherein the filtered audio streams comprise at least one unaided filtered audio stream and at least one aided filtered audio stream.

6. The system of claim 5 wherein the at least one aided filtered audio stream was filtered using PC filters derived from principal components analysis of a set of hearing aid-related transfer functions (HARTFs).

7. The system of claim 6 wherein the at least one weighted audio stream comprises at least one unaided weighted audio stream and at least one aided weighted audio stream.

8. The system of claim 7 wherein the at least one aided weighted audio stream was weighted using PC weights derived from principal components analysis of the set of HARTFs.

9. The system of claim 5 wherein the at least one sound source signal of the input audio signal represents at least one of: direct sound from a source; a reflection off of a surface in a virtual environment; reverberation from a target direction; a virtual loudspeaker recreating a sound field.

10. The system of claim 1 wherein the set of HRTFs is transformed into a set of head-related impulse responses (HRIRs) prior to principal components analysis.

11. The system of claim 1 wherein the principal components analysis to generate the PC filters is performed on combined real and imaginary components of the set of HRTFs, to generate the PC filters in the frequency domain.

12. The system of claim 11 wherein frequency-domain PC filters resulting from the principal components analysis are transformed to time-domain FIR filters.

13. The system of claim 1 wherein the PC filters are designed to be infinite impulse response (IIR) filters.

14. A method for allowing a listener to hear the effect of hearing aids in a simulated environment, comprising:
receiving an audio signal comprising a multiple sound source signals in an audio environment;
applying PC weights and PC filters to each of the sound source signals to result in a set of weighted, filtered channels, wherein some of the PC weights and PC filters are based upon a set of HRTFs and some of the PC weights and PC filters are based upon a set of HARTFs;
summing the weighted, filtered channels into at least one unaided output and at least one aided output; and
rendering a simulated audio environment to the listener, wherein the simulated sound environment can selectively be based upon the unaided output or a combination of the unaided output and the aided output to thereby allow the listener to hear the effect of using a hearing aid or not in the simulated environment.

15. The method of claim 14 wherein the at least one unaided output and at least one aided output are transmitted to one or more hearing aids for playback to the listener.

16. The method of claim 14 wherein the at least one unaided output comprises right and left unaided output channels and the at least one aided output comprises right and left aided output channels, and further wherein:
the right unaided output channel and right aided output channel are summed into a right output signal;
the left unaided output channel and left aided output channel are summed into a left output signal; and
the right and left output signals are transmitted to headphones for playback to the listener.

17. The method of claim 14, further comprising applying a time delay to the multiple sound source signals, prior to applying the PC weights.

18. The method of claim 17 wherein each time delay is selected from a set of ITD delays according to directional information of a sound source signal, the ITD delays having been obtained from a principal components analysis of the set of HRTFs, for each direction in which an HRTF was measured.

19. The method of claim 14 wherein the set of HRTFs and the set of HARTFs are transformed into a set of head-related impulse responses (HRIRs) and hearing aid-related impulse responses (HARIRs), respectively, prior to principal components analysis.

20. The method of claim 14 wherein the principal components analysis to generate the PC filters is performed on combined real and imaginary components of the set of HRTFs and the set of HARTFs, to generate the PC filters in the frequency domain.

21. The method of claim 20 wherein frequency-domain PC filters resulting from the principal components analysis are transformed to time-domain FIR filters.

22. The method of claim 13 wherein the PC filters are designed to be infinite impulse response (IIR) filters.

23. A method for simulating an acoustic environment of a virtual reality setting, comprising:
receiving an audio signal comprising multiple sound source signals in an audio environment, the audio environment corresponding to a visual environment to be displayed to a user via virtual reality;
applying PC weights and PC filters to each of the multiple sound source signals, to result in a set of weighted, filtered channels, the PC weights and PC filters having been derived from a set of device-related transfer functions (DRTFs);
summing the weighted, filtered channels into at least two outputs; and
rendering a simulated audio environment to a listener via at least two speakers.
